(19) United States
(12) Patent Application Publication
(10) Pub. No.: US 2023/0365051 A1
(43) Pub. Date: Nov. 16, 2023

(54) Cable Support Safety System for Semi-Trailers

(71) Applicant: Tony Stone, Youngstown, OH (US)

(72) Inventor: Tony Stone, Youngstown, OH (US)

(21) Appl. No.: 18/316,618

(22) Filed: May 12, 2023

Related U.S. Application Data
(60) Provisional application No. 63/340,976, filed on May 12, 2022.

(51) Int. Cl. B60P 7/15; B62D 63/08

(52) U.S. Cl. CPC B60P 7/15; B62D 63/08; B62D 33/04

(57) ABSTRACT

The present invention relates generally to the field of semi-trailers. More specifically, the present invention relates to a cable support safety system for semi-trailers, primarily comprised of at least one spring pole, at least one main cable, and at least one spring pole retention cable. The main cable can be secured along the length of the trailer roof, wherein the spring pole retention cable can then be secured to the cable and to the spring pole after the spring pole is secured within a semi-trailer. In this manner, the spring pole can only move the length of the retention cable if the spring pole is dislodged or moved.

### CROSS-REFERENCE TO RELATED APPLICATION

The present application claims priority to, and the benefit of, U.S. Provisional Application No. 63/340,976 which was filed on May 12, 2022, and is incorporated herein by reference in its entirety.

### FIELD OF THE INVENTION

The present invention relates generally to the field of semi-trailers. More specifically, the present invention relates to a cable support safety system for semi-trailers primarily comprised of at least one spring pole, at least one main cable, and at least one spring pole retention cable. The main cable can be secured along the length of the trailer roof, wherein the spring pole retention cable can then be secured to the cable and to the spring pole after the spring pole is secured within a semi-trailer. In this manner, the spring pole can only move the length of the retention cable if the spring pole is dislodged or moved. Accordingly, the present disclosure makes specific reference thereto. Nonetheless, it is to be appreciated that aspects of the present invention are also equally applicable to other like applications, devices, and methods of manufacture.

### BACKGROUND

A spring pole is a spring-loaded device that is used within a semi-trailer to separate contents of the trailer during transport. Spring poles typically run from the floor of the semi-trailer to the ceiling and attach to the ceiling of the trailer. Semi-trailer spring poles are often knocked out of place or off a semi-trailer during the loading/unloading process, which may result in serious injury or death.

Therefore, there exists a long-felt need in the art for a system that prevents semi-trailer spring poles from being knocked out of place or off a semi-trailer during the loading/unloading process. In addition, there exists a long-felt need in the art for a cable support safety system for semi-trailers that retain spring poles within a semi-trailer. Further, there exists a long-felt need in the art for a cable support safety system for semi-trailers that retains spring poles within a semi-trailer, and wherein the system can be attached to a plurality of spring poles within a semi-trailer.

The subject matter disclosed and claimed herein, in one embodiment thereof, comprises a cable support safety system for semi-trailers. The system is primarily comprised of at least one spring pole, at least one main cable, and at least one spring pole retention cable. The system is designed to be used within a semi-trailer, wherein at least one spring pole contacts the trailer roof and trailer floor during use. The main cable can be secured along the length of the trailer roof, wherein the spring pole retention cable can then be secured to the cable and to the spring pole. In this manner, the spring pole can only move the length of the retention cable if the spring pole is dislodged or moved.

In this manner, the cable support safety system for semi-trailers of the present invention accomplishes all of the foregoing objectives and provides a system that prevents semi-trailer spring poles from being knocked out of place or off a semi-trailer during the loading/unloading process. In addition, the system retains spring poles within a semi-trailer. Furthermore, the system can be attached to a plurality of spring poles within a semi-trailer and ensures said spring poles do not injure nearby individuals if dislodged or moved.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable support safety system for semi-trailers. The system is primarily comprised of at least one spring pole, at least one main cable, and at least one spring pole retention cable. The system is designed to be used within a semi-trailer, wherein at least one spring pole contacts the trailer roof and trailer floor during use. The spring pole has an outer body and an inner body located within the outer body, wherein the outer body is repositionable along the inner body to allow the spring pole to adjust in height. The outer body and inner body are further comprised of at least one continuous opening that allows at least one pin to be aligned through the openings to allow the spring pole to become fixed at a specific height. The outer body is further comprised of a top end that may be rounded and/or grooved in order to fit within the frame of a semi-trailer roof.

The inner body may further be comprised of at least one foot that contacts the floor of the trailer. In doing so, the foot stabilizes the spring pole during use. The spring pole is further comprised of at least one internal spring which undergoes compression when the top end and foot are positioned such that they contact the floor and trailer roof. As a result, the compressive force secures the spring pole in a vertical position that is perpendicular to the trailer roof and floor.

The main cable of the system preferably runs the entire length of the semi-trailer and attaches to the roof (or at least one frame member of the roof) via at least one eyelet. The spring pole retention cable is comprised of a first end and a second end. The first and second ends are further preferably comprised of at least one clip such as, but not limited to, a swivel eye bolt snap clip and/or a quick snap clip. The clip of the first end preferably attaches to the main cable, and wherein the clip of the second end preferably attaches to at least one eyelet located on the outer body of the spring pole. Therefore, the spring pole is attached to the main cable such that the spring pole can only move a limited distance (i.e., the length of the retention cable) if dislodged from the semi-trailer.

The system is also comprised of a method of using the system. To begin the method, a user secures at least one eyelet to a trailer roof and/or trailer roof frame. Then, the main cable is fed through the eyelet. Next, the spring pole is adjusted to the proper height by pulling the outer body outward (or pushing the outer body inward) in relation to the inner body and placing a pin in the openings of the outer body and inner body after aligning said openings. Next, the top end and foot of the spring pole are positioned to contact the floor and roof such that a compressive force is placed on the spring. This force secures the spring pole in a vertical position perpendicular to the floor and roof. Then, the retention cable is secured to the main cable via the clip at the first end and is secured to the eyelet of the spring pole via the clip at the second end. As a result, the spring pole is securely retained and cannot fall or become dislodged and injure nearby individuals.

Accordingly, the cable support safety system for semi-trailers of the present invention is particularly advantageous as it provides a system that prevents semi-trailer spring poles from being knocked out of place or off a semi-trailer during the loading/unloading process and retains spring poles within a semi-trailer. Further, the system can be attached to a plurality of spring poles within a semi-trailer and ensures said spring poles do not injure nearby individuals if dislodged or moved. In this manner, the cable support safety system for semi-trailers provides a novel safety solution to use spring poles in semi-trailers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a cable support safety system for semi-trailers, while installed within a semi-trailer, of the present invention in accordance with the disclosed architecture;

FIG. 2 illustrates a perspective view of one potential embodiment of a cable support safety system for semi-trailers, while installed within a semi-trailer, of the present invention in accordance with the disclosed architecture; and

FIG. 3 illustrates a flow chart of one potential method of using one potential embodiment of a cable support safety system for semi-trailers of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that prevents semi-trailer spring poles from being knocked out of place or off a semi-trailer during the loading/unloading process. In addition, there exists a long-felt need in the art for a cable support safety system for semi-trailers that retains spring poles within a semi-trailer. Further, there exists a long-felt need in the art for a cable support safety system for semi-trailers that retain spring poles within a semi-trailer, and wherein the system can be attached to a plurality of spring poles within a semi-trailer.

The present invention, in one exemplary embodiment, is comprised of a cable support safety system for semi-trailers, primarily comprised of at least one spring pole, at least one main cable, and at least one spring pole retention cable. The system is designed to be used within a semi-trailer. During use, at least one spring pole contacts the trailer roof and trailer floor. The spring pole has an outer body and an inner body located within the outer body. The outer body is repositionable along the inner body to allow the spring pole to adjust in height. The outer body and inner body are further comprised of at least one continuous opening. The opening allows at least one pin to be aligned through the openings to allow the spring pole to become fixed at a specific height. Further, the outer body is comprised of a top end that may be rounded and/or grooved in order to fit within the frame of a semi-trailer roof.

The inner body may further be comprised of at least one foot. The foot contacts the floor of the trailer. In doing so, the foot stabilizes the spring pole during use. The spring pole is further comprised of at least one internal spring within the inner body and outer body. The spring undergoes compression when the top end and foot are positioned such that they contact the floor and trailer roof. As a result, the compressive force secures the spring pole in a vertical position that is perpendicular to the trailer roof and floor.

The main cable of the system preferably runs the entire length of the semi-trailer and attaches to the roof (or at least one frame member of the roof) via at least one eyelet. The spring pole retention cable is comprised of a first end and second end. The first and second ends are further preferably comprised of at least one clip such as, but not limited to, a swivel eye bolt snap clip and/or a quick snap clip. The clip of the first end preferably attaches to the main cable. The clip of the second end preferably attaches to at least one eyelet located on the outer body of the spring pole. Therefore, the spring pole is attached to the main cable such that the spring pole can only move a limited distance (i.e., the length of the retention cable) if dislodged from the semi-trailer.

The system is also comprised of a method of using the system. First, a user secures at least one eyelet to a trailer roof and/or trailer roof frame. Then, the main cable is fed through the eyelet. Next, the spring pole is adjusted to the proper height by pulling the outer body outward (or pushing the outer body inward) in relation to the inner body and placing a pin in the openings of the outer body and inner body after aligning said openings. Next, the top end and foot of the spring pole are positioned to contact the floor and roof such that a compressive force is placed on the spring. This force secures the spring pole in a vertical position perpendicular to the floor and roof. Then, the retention cable is secured to the main cable via the clip at the first end and is secured to the eyelet of the spring pole via the clip at the second end. As a result, the spring pole is securely retained and cannot fall or become dislodged and injure nearby individuals.

Accordingly, the cable support safety system for semi-trailers of the present invention is particularly advantageous as it provides a system that prevents semi-trailer spring poles from being knocked out of place or off a semi-trailer during the loading/unloading process and retains spring poles within a semi-trailer. Further, the system can be attached to a plurality of spring poles within a semi-trailer and ensures said spring poles do not injure nearby individuals if dislodged or moved. In this manner, the cable support safety system for semi-trailers provides a novel safety solution to use spring poles in semi-trailers.

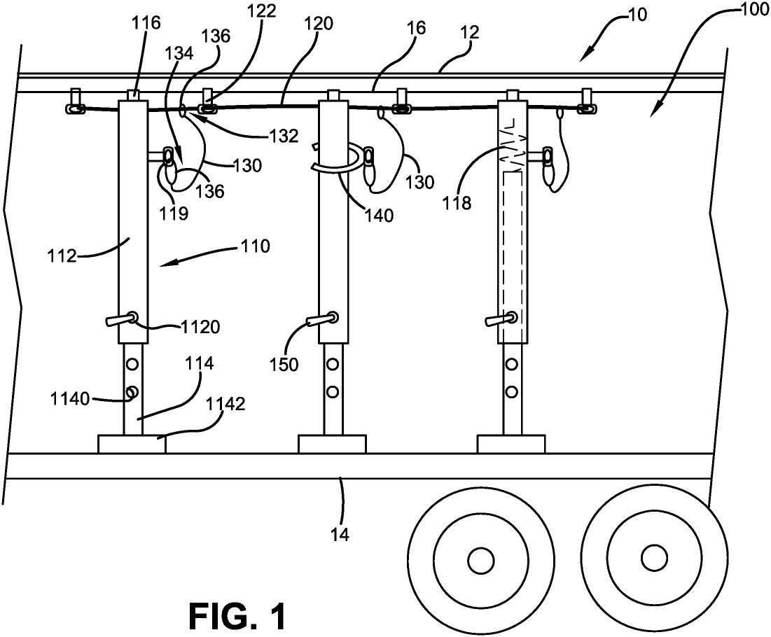

Referring initially to the drawings, FIG. 1 illustrates a side view of one potential embodiment of a cable support safety system for semi-trailers 100, while installed within a semi-trailer 10, of the present invention in accordance with the disclosed architecture. The system 100 is primarily comprised of at least one spring pole 110, at least one main cable 120, and at least one spring pole retention cable 130. Unless otherwise specified herein, all components of the system 100 are manufactured from a durable metal such as stainless steel or aluminum. The system 100 is designed to be used within a semi-trailer 10, wherein at least one spring pole 110 contacts the trailer roof 12 and trailer floor 14 during use.

The spring pole 110 has an outer body 112 and an inner body 114 located within the outer body 112. The outer body 112 is repositionable along the inner body 114 to allow the spring pole 110 to adjust in height. The outer body 112 and inner body 114 are further comprised of at least one continuous opening 1120,1140 that allows at least one pin 150 to be aligned through the openings 1120,1140 to allow the spring pole 110 to become fixed at a specific height. In one embodiment, the spring pole 110 is only comprised of an inner body 114 and is of a fixed length. The outer body 112 is further comprised of a top end 116. The top end 116 may be rounded and/or grooved in order to fit within the frame 16 of a semi-trailer roof 12.

The inner body 114 may further be comprised of at least one foot 1142. The foot 1142 contacts the floor 14 of the trailer 10 and stabilizes the spring pole 110 during use. The spring pole 110 is further comprised of at least one internal spring 118 located between the inner body 114 and outer body 112. The internal spring 118 undergoes compression when the top end 116 and foot 1142 are positioned such that they contact the floor 14 and trailer roof 12. In this manner, the compressive force secures the spring pole 110 in a vertical position that is perpendicular to the trailer roof 12 and floor 14.

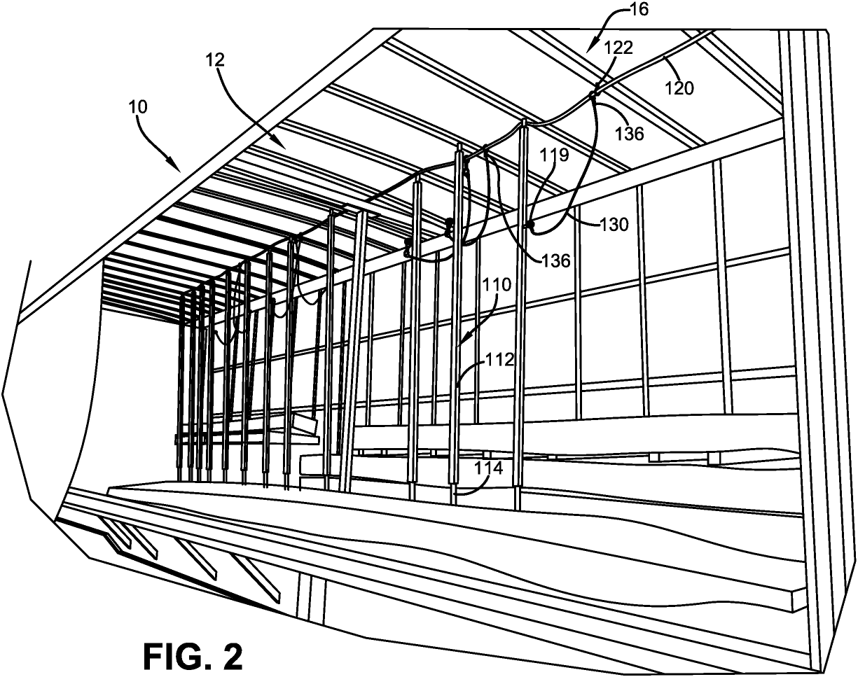

The main cable 120 of the system preferably runs the entire length of the semi-trailer 10 and attaches to the roof 12 (or at least one frame 16 member of the roof 12) via at least one eyelet 122, as seen in FIG. 1 and FIG. 2. The eyelet 122 may be threaded or magnetic in order to attach to the roof 12 and/or frame 16. In differing embodiments, the main cable 120 may be made from a plurality of materials such as, but not limited to: vinyl-coated wire rope, metal-braided rope, vinyl-coated metal-braided rope, steel cable, chain, vinyl-covered chain, etc.

The spring pole retention cable 130 is preferably manufactured from the same material as the main cable 120. The first end 132 and second end 134 of the retention cable 130 are further preferably comprised of at least one clip 136. In the preferred embodiment, the clip 136 is a swivel eye bolt snap clip and/or a quick snap clip. However, the clip 136 may be any type of clip known in the art in differing embodiments. The clip 136 of the first end 132 preferably attaches to the main cable 120. The clip 136 of the second end 134 preferably attaches to at least one eyelet 119 located on the outer body 112 of the spring pole 110. In this manner, the spring pole 110 is bound to the main cable 120 such that the spring pole 110 can only move a limited distance (i.e., the length of the retention cable 130) if dislodged from the semi-trailer 10.

In one embodiment, the second end 134 is comprised of at least one clamp 140 instead of at least one clip 136. The clamp 140 can be removably clamped to the outer body 112 of the spring pole 110 to removably attach the retention cable 130 to the spring pole 110. The clamp 140 may be any clamp-type known in the art.

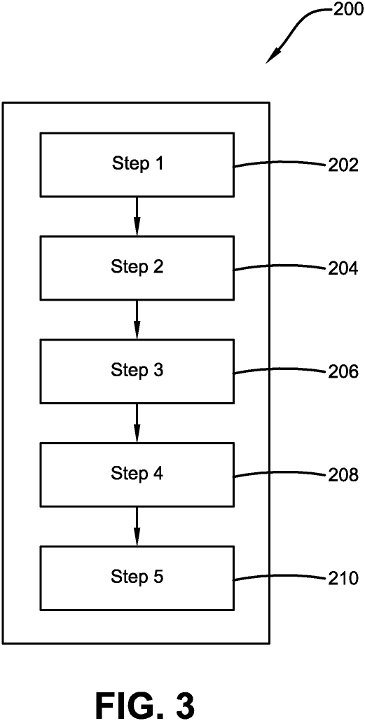

FIG. 3 illustrates a flow chart of one potential method 200 of using one potential embodiment of a cable support safety system for semi-trailers 100 of the present invention in accordance with the disclosed architecture. The system 100 is also comprised of a method of using the system 200. First, a user secures at least one eyelet 122 to a trailer roof 12 and/or trailer roof frame 16 [Step 202]. Then, the main cable 120 is fed through the eyelet 122 [Step 204]. Next, the spring pole 110 is adjusted to the proper height by pulling the outer body 112 outward (or pushing the outer body 112 inward) in relation to the inner body 114 and placing a pin 150 in the openings 1120,1140 after aligning said openings 1120,1140 [Step 206]. Next, the top end 116 and foot 1142 of the spring pole 110 are positioned to contact the floor 14 and roof 12 such that a compressive force is placed on the spring 118 to secure the spring pole 110 in a vertical position perpendicular to the floor 14 and roof 12 [Step 208]. Then, the retention cable 130 is secured to the main cable 120 via the clip 136 at the first end 132 and is secured to the eyelet 119 of the spring pole 110 via the clip 136 (and/or clamp 140) at the second end 134. [Step 210]. As a result, the spring pole 110 is securely retained and cannot fall or become dislodged and injure nearby individuals.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cable support safety system for semi-trailers” and “device” are interchangeable and refer to the cable support safety system for semi-trailers 100 of the present invention.

Notwithstanding the foregoing, the cable support safety system for semi-trailers 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cable support safety system for semi-trailers 100 as shown in the FIGS. are for illustrative purposes only, and that many other sizes and shapes of the cable support safety system for semi-trailers 100 are well within the scope of the present disclosure. Although the dimensions of the cable support safety system for semi-trailers 100 are important design parameters for user convenience, the cable support safety system for semi-trailers 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable support safety system for a semi-trailer, the cable support safety system comprising:
a main cable;
an eyelet; and
a spring pole retention cable having a first end and a second end.

2. The cable support safety system for a semi-trailer of claim 1 further comprising a clip positioned at the first end.

3. The cable support safety system for a semi-trailer of claim 1 further comprising a clip positioned at the second end.

4. The cable support safety system for a semi-trailer of claim 1, wherein the eyelet is a threaded eyelet or a magnetic eyelet.

5. A cable support safety system for a semi-trailer, the cable support safety system comprising:
a main cable;
a first eyelet;
a spring pole comprised of an outer body, an inner body, a spring and a second eyelet; and
a spring pole retention cable having a first end and a second end.

6. The cable support safety system for a semi-trailer of claim 5 further comprising a swivel eye bolt snap clip positioned on the first end.

7. The cable support safety system for a semi-trailer of claim 6 further comprising a quick snap clip positioned on the second end.

8. The cable support safety system for a semi-trailer of claim 5 further comprising a clamp positioned on the second end.

9. The cable support safety system for a semi-trailer of claim 5, wherein each of the main cable and the spring pole retention cable is comprised of a vinyl-coated wire rope, a metal-braided rope, a vinyl-coated metal-braided rope, a steel cable, a chain or a vinyl-covered chain.

10. The cable support safety system for a semi-trailer of claim 5 further comprising a foot positioned on the inner body.

11. The cable support safety system for a semi-trailer of claim 5, wherein each of the inner body and the outer body comprise an opening.

12. The cable support safety system for a semi-trailer of claim 5 further comprising a pin.

13. The cable support safety system for a semi-trailer of claim 5, wherein the spring pole comprises an adjustable height.

14. The cable support safety system for a semi-trailer of claim 5, wherein a top end of the outer body of the spring pole is rounded.

15. The cable support safety system for a semi-trailer of claim 5, wherein the spring is positioned within between the inner body and the outer body.

16. A method of using a cable support safety system for a semi-trailer, the method comprising the steps of:
securing a first eyelet of the cable support safety system to a trailer roof or a trailer roof frame;
feeding a main cable of the cable support safety system through the first eyelet;
adjusting a spring pole of the cable support safety system to a desired height by pulling an outer body of the spring pole outwards in relation to an inner body of the spring pole and placing a pin through an opening in the outer body and through an opening in the inner body;
positioning a top end and positioning a foot of the spring pole such that the spring pole contacts a trailer floor and the trailer roof so that a compressive force is placed on an internal spring within the spring pole to secure the spring pole in a vertical position and perpendicular to the trailer floor and the trailer roof;
securing a spring pole retention cable to the main cable via a clip at a first end of the spring pole retention cable; and
securing a spring pole retention cable to a second eyelet of the spring pole via a clip at a second end of the spring pole.

17. The method of claim 16, wherein the method is alternatively comprised of pushing the outer body inwards relative to the inner body instead of pulling the outer body of the spring pole outwards in relation to the inner body.

18. The method of claim 16, wherein the opening of the outer body and the opening of the inner body are aligned before the pin is placed through the opening of the outer body and through the opening of the inner body.

19. The method of claim 16, wherein the second end of the spring pole retention cable is alternatively comprised of a clamp instead of a clip.

20. The method of claim 19, wherein the clamp is clamped to the outer body of the spring pole.
